(19) United States
(12) Patent Application Publication
(10) Pub. No.: US 2013/0173137 A1
(43) Pub. Date: Jul. 4, 2013

(54) SYSTEM, APPARATUS, AND METHOD FOR PROTECTING VEHICLE ENGINES

(71) Applicant: GENERAL ELECTRIC COMPANY, Schenectady, NY (US)

(72) Inventors: Suseel Sukumaran, Bangalore (IN); Rekha Doddarangaiah Prasad, Grove City, PA (US); Kabitanjali Panigrahi, Bangalore (IN); Subodh Khadmale, Bangalore (IN); Pritamkumar Rameshchandra Gangwal, Bangalore (IN)

(73) Assignee: GENERAL ELECTRIC COMPANY, Schenectady, NY (US)

(21) Appl. No.: 13/723,630

(22) Filed: Dec. 21, 2012

Related U.S. Application Data
(60) Provisional application No. 61/581,425, filed on Dec. 29, 2011.

(51) Int. Cl. F02D 45/00

(52) U.S. Cl. CPC F02D 45/00
USPC 701/102

(57) ABSTRACT

A method includes providing a run-time configurable engine protection configuration that is stored in an engine protection module that is linked to a sensor associated with an engine. The method also includes identifying an engine protection setting corresponding to the engine protection configuration. The engine protection setting includes at least three of a threshold value, a unique message, an action or an alarm. The method further includes presenting the engine protection setting to an operator via an interface. The interface includes at least one of a control panel or a computing device. Also, the method includes receiving, via the interface, an instruction corresponding to a revised engine protection setting. Further the method includes updating, during run-time, the engine protection configuration pursuant to the instruction to reflect the revised engine protection setting, responsive to the receiving of the instruction corresponding to the revised engine protection setting.

### RELATED APPLICATIONS

This application claims priority to U.S. Provisional Application Ser. No. 61/581,425, filed 29 Dec. 2011, and entitled “System, Apparatus, and Method for Protecting Marine Vehicle Engines,” the content of which is hereby incorporated by reference in its entirety.

### TECHNICAL FIELD

Embodiments of the invention relate to the field of engine protection. Other embodiments relate to systems, apparatuses, and/or methods for protecting vehicle engines, for example, marine vehicle engines.

### BACKGROUND

Diesel engine controllers may include modules that perform various functions. These functions may include safety, in/out logic, engine control, and alarm functionality. Commercially available engine controllers may have hardware-based solutions that provide each of the previously identified functions on standalone hardware boards. Apart from an industry design approach, regulations can mandate that certain functions, such as the alarm, be housed in hardware that is physically distinct from other modules.

### BRIEF DESCRIPTION

In one embodiment, a method (e.g., a method for establishing, initiating, or modifying engine protection configurations) is provided. The method includes creating a run-time configurable engine protection configuration. The engine protection configuration is stored in an engine protection module that is linked to a sensor associated with an engine. The method also includes identifying an engine protection setting corresponding to the engine protection configuration. The engine protection setting includes at least three of a threshold value, a unique message, an action, or an alarm. The method further includes presenting the engine protection setting to an operator via an interface. The interface includes at least one of a control panel or a computing device. Also, the method includes receiving, via the interface, an instruction corresponding to a revised engine protection setting. The method also includes updating, during run-time of the engine, the engine protection configuration pursuant to the instruction to reflect the revised engine protection setting, responsive to the receiving of the instruction corresponding to the revised engine protection setting.

In another embodiment, a system (e.g., a system for engine protection) is provided. The system includes an engine protection module and a data store. As used herein, the terms “system” and “module” include a hardware and/or software system that operates to perform one or more functions. For example, a module or system may include a computer processor, controller, or other logic-based device that performs operations based on instructions stored on a tangible and non-transitory computer readable storage medium, such as a computer memory. Alternatively, a module or system may include a hard-wired device that performs operations based on hard-wired logic of the device. The modules shown in the attached figures may represent the hardware that operates based on software or hardwired instructions, the software that directs hardware to perform the operations, or a combination thereof.

The engine protection module is configured for run-time updating of an engine protection configuration associated with an engine. The protection configuration includes a protection setting having at least three of a threshold value, a unique message, an action, or an alarm. The data store is configured to persist at least one of the engine protection configuration or an alarm log. The alarm log includes at least one of a timestamp, an engine state, a threshold, or an alarm message.

In another embodiment, a tangible and non-transitory computer readable medium includes one or more computer software modules. The computer software modules are configured to direct a processor to provide a run-time configurable engine protection configuration, identify an engine protection setting corresponding to the engine protection configuration, present the engine protection setting to an operator via an interface, receive, via the interface, an instruction corresponding to a revised engine protection setting, and update, during run-time, the engine protection configuration. The engine protection configuration is stored in an engine protection module that is linked to a sensor associated with the engine. The engine protection setting includes at least three of a threshold value, a unique message, an action, or an alarm. The interface includes at least one of a control panel or a computing device. The engine protection configuration is updated pursuant to the instruction to reflect the revised engine protection setting, responsive to receiving the instruction corresponding to the revised engine protection setting.

### BRIEF DESCRIPTION OF THE DRAWINGS

FIG. 1 is a flowchart illustrating a method for engine protection management in accordance with an embodiment.

FIG. 2 is a schematic diagram illustrating a system in accordance with an embodiment.

FIG. 3 is a schematic diagram illustrating an interface in accordance with an embodiment.

### DETAILED DESCRIPTION

Engine control units (ECU) may be used in connection with engines, for example, diesel engines for use in marine applications. An ECU may collect and process signals from various on-board sensors. An ECU electronic module may contain microprocessors, memory units, analog to digital converters, and output interface units. An ECU may be tailored to the specific engine and vehicle requirements. Operating software of the ECU may be configured to allow for adaptation and use, but may be constrained by hardware restrictions or limitations. In some applications, an ECU may need protection from harsh environmental conditions. Cooling of the ECU may be desirable in applications involving sufficient exposure to heat, for example. Further, in some embodiments, dust and vibration may need to be accounted for.

Safety functionality may be used to refer to the protection of the engine (for example, an engine shutdown) if one or more operating parameters indicate conditions sufficiently harmful to the engine. As an example, the 3.8 megawatt (MW) WARTSILA brand Marine Generator Set includes, as main components, an engine safety module for shutdown of an engine according to class requirements, a main control module for internal engine control functions, an alarm module, and input/output modules for handling of sensor data.

However, it would be beneficial to provide an ECU or similar control or protection module or unit that differs from traditional solutions, and provides improved functionality.

Embodiments of the present inventive subject matter provide for unifying engine protection management, for example, within a vehicle. Some embodiments relate to engine protection management within a marine vehicle, or within another vehicle. In embodiments, an engine protection configuration associated with a sensor can be presented to an operator via an interface. The sensor may be a sensor linked (e.g., operatively connected) to an engine and/or an engine component within the vehicle. The interface may be configured to allow an operator to select, configure, and/or modify engine protection settings of the engine protection configuration. Protection settings may include, by way of example and not limitation, a threshold value, a message, an action, an alarm, or the like. In some embodiments, a system may be configured for alteration of engine protection settings without necessitating a panel power-cycling operation. For example, alteration of one or more engine protection settings can be performed and propagated throughout the system automatically in order to allow uninterrupted functioning of a control panel.

Embodiments of the present inventive subject matter provide for engine protection configurations that are run-time configurable. Run-time (or execution time) may be understood as the time during which a software program (e.g., a program configured to monitor engine operation) is running or executing. Other temporal phases associated with a software program may include compile time, link time, load time, or the like. Marine engines, for example, may be operable in a variety of different applications or modes, with a different configuration of engine protection settings appropriate for each different application or mode. Conventional hardware protective schemes may be quite difficult and time consuming to change. Embodiments of the present inventive subject matter provide for quicker, more convenient, and more user-friendly configuration of engine protection settings (e.g., thresholds and associated messages and/or actions) tailored for a given application, customer, condition, or the like, for example, while the engine is operating to propel the vehicle. Embodiments also provide coupling of various aspects of an engine protection configuration (e.g., a threshold with one or more of an alarm or action) for convenient configuration. A technical effect of at least one embodiment includes improved ease of configuring an engine protection system. A technical effect of at least one embodiment includes reduced time for configuring an engine protection system and/or implementing an update to the configuration of an engine protection system. A technical effect of at least one embodiment includes reduced expense of configuring an engine protection system. A technical effect of at least one embodiment includes operating an engine according to an engine protection system that is configured (e.g., run-time configured) as set forth herein.

Aspects of the inventive subject matter may be embodied as a system, method, or computer program product. Accordingly, aspects of the inventive subject matter may take the form of an entirely hardware-based embodiment, an entirely software-based embodiment (including firmware, resident software, micro-code, etc.), or an embodiment combining software and hardware aspects that may all generally be referred to herein as a “circuit,” “module” or “system.” Furthermore, aspects of the inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of computer readable storage media would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the inventive subject matter are described below with reference to flowchart illustrations and/or block diagrams of methods, apparatus (e.g., systems) and computer program products according to embodiments of the invention. To the extent that the figures illustrate diagrams of the functional blocks of various embodiments, the functional blocks are not necessarily indicative of the division between hardware circuitry. Thus, for example, one or more of the functional blocks (e.g., processors, controllers or memories) may be implemented in a single piece of hardware (e.g., a general purpose signal processor or random access memory, hard disk, or the like) or multiple pieces of hardware. Similarly, any programs may be stand-alone programs, may be incorporated as subroutines in an operating system, may be functions in an installed software package, and the like. It should be understood that the various embodiments are not limited to the arrangements and instrumentality shown in the drawings. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

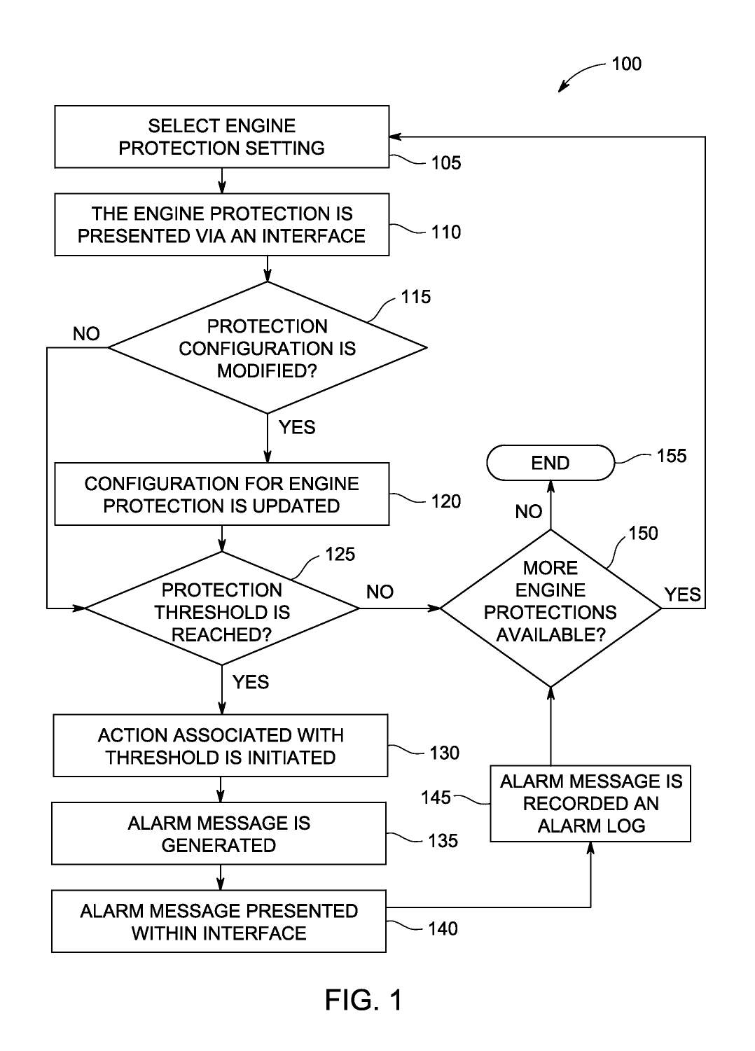

FIG. 1 is a flowchart illustrating a method 100 for unifying engine protection management within a vehicle (or other engine-based device, such as a generator) in accordance with an embodiment of the present inventive subject matter. The method 100 may be performed, for example, using certain components, equipment, structures, or other aspects of embodiments discussed above. In certain embodiments, certain steps may be added or omitted, certain steps may be performed simultaneously or concurrently with other steps, certain steps may be performed in different order, and certain steps may be performed more than once, for example, in an iterative fashion.

The method 100 may be performed, for example, using all or a portion of system 200 and/or interface 300 discussed herein. In method 100, an engine (e.g., an engine within a vehicle such as a marine vehicle) may be managed utilizing an engine protection module. Engine protection may be manually and/or automatically established, configured, modified, and/or updated. An engine protection configuration and/or setting may be presented within an interface configured to allow an operator to easily manage multiple engine protection settings, such as thresholds, alarms, and the like. In one embodiment, the interface may permit configuration of actions associated with an engine protection configuration. For example, user-selected actions may be automatically performed when a threshold of an engine protection setting is met or exceeded. When engine operational parameters meet or exceed a threshold value of an engine protection setting, an action corresponding to the threshold that has been configured by an operator may be performed to safeguard the engine. In some embodiments, an external tool (such as a laptop and/or external software in addition to engine control software) may not be required to configure an engine protection configuration.

It should be appreciated that method 100 may operate within an infrastructure conforming to devices communicatively linked together permitting resources to interact in real-time or near real-time. The method may facilitate unified engine protection configurations. For example, the method 100 may be employed in the context of a marine vehicle having multiple engine systems, sensors, alarms, protections, and the like. These multiple systems, sensors, and protections, may be communicatively linked together and operate according to a monolithic engine protection configuration that has configuration settings applicable to all or many of the systems, sensors, and protections.

As described herein, the term “operator” may include any proximate or remote personnel associated with the operation and/or management of an engine, for example, an engine of a marine vehicle. The operator may include, but is not limited to, an engineer, a seaman, a marine operations manager, and the like. The operator may interact with one or more interfaces that may be associated with systems or methods described herein.

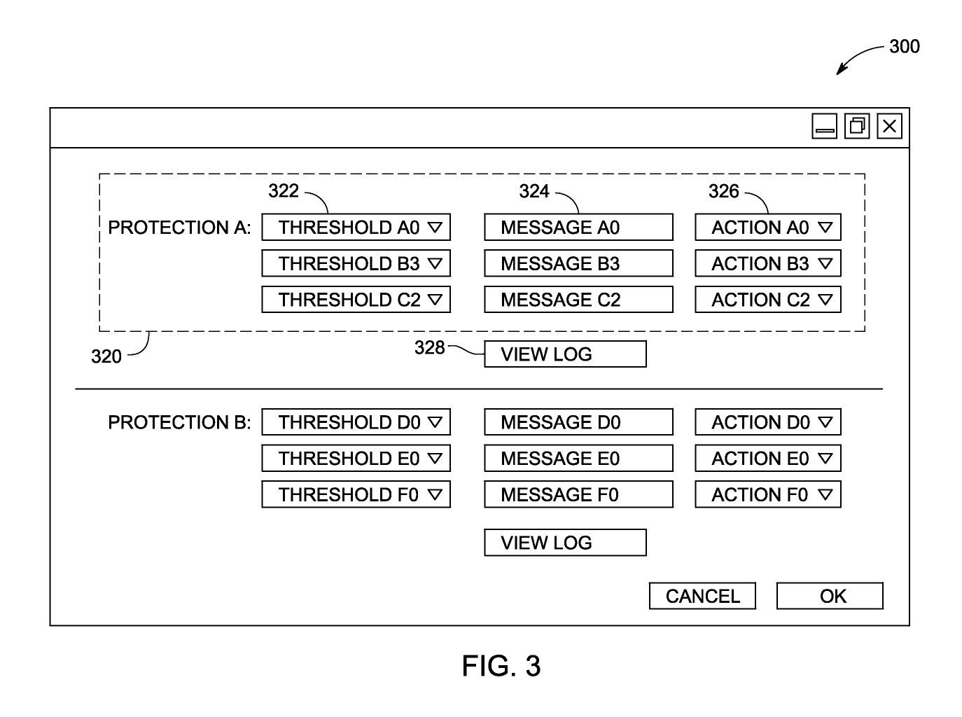

At 105, an engine protection setting of an engine protection configuration is selected. The engine protection setting, for example, may be associated with an engine within a vehicle, such as a marine vehicle or other vehicle, or other engine-based device. The engine protection setting may include, but is not limited to, a threshold value, a unique message, an action, and/or an alarm. The engine protection setting may also include a grouping of such settings, such as a threshold value having a corresponding message, action, and/or alarm. (See also FIG. 3 and related discussion.) At 110, the engine protection setting is presented via an interface. The interface may include one or more screens or other displays including engine protection information, protection settings, recommended protection settings, historic settings, and the like. The interface may be associated with a computing device including, but not limited to, a control panel, a navigation device, desktop computer, a laptop, a tablet computing device, a personal digital assistant (PDA), a mobile phone, or the like.

At 115, it is determined if one or more settings of an engine protection configuration are to be modified. If one or more aspects of an engine protection configuration are to be modified, the method may proceed to step 120. The method proceeds to step 125 if no modification is to be made. Modification may include adjusting one or more threshold values, message parameters, operational actions, alarm settings, or the like, of the engine protection settings. In some embodiments, an engine protection setting to be modified may include at least three of the following: a threshold value, a unique message, an action, or an alarm. The threshold value, unique message, action, and/or alarm may be associated together to appropriately address a given threshold satisfaction (e.g., by an action) as well as to provide notice and/or additional information (e.g., by a message and/or alarm) to an operator regarding the threshold satisfied and/or the action taken. The threshold value, unique message, action, and/or alarm may be conveniently and accurately updated as components of a single engine protection setting. Modification may be performed manually and/or automatically. For instance, an engine protection adjustment may be performed through manual interaction of an operator with interface elements of a screen. As another example, modification of settings may be performed automatically based on a condition under which the engine is performing, or a based on a detected mode of operation. At 120, a configuration for the engine protection may be updated. In some embodiments, the update may be performed in real-time or near real-time. For example, the update may be achieved without requiring a control panel associated with the engine protection configuration to be power-cycled. For instance, an instrument panel may automatically receive and present in real-time a current (e.g., updated) engine protection configuration in response to an engine protection update. Such an update may occur and be implemented while the engine is operating to produce electric current and/or to propel the vehicle. Such an update may also occur and be implemented while a program monitoring the operation of the engine is running or executing. In some embodiments, the modification or update of engine protection settings may be performed without the use of an external tool (such as a laptop and/or external software in addition to engine control software). For example, in some embodiments, engine control software may be employed having an updating functionality built in.

At 125, if a threshold value setting of the engine protection configuration is satisfied (e.g., met or exceeded), the method may continue to step 130. If not, the method may proceed to step 150. An engine protection threshold may include, by way of example and not limitation, a limit on an engine operational parameter, multiple engine operational parameters, or the like. Protection thresholds may include values including, but not limited to, numeric, alphanumeric, and the like. For example, a protection threshold may be an engine operation value such as a rotational speed of the engine (e.g., six hundred rotations per minute (RPM)). A protection threshold may be evaluated periodically or continually to permit real-time engine protection. In one embodiment, sensor information received from a sensor associated with an engine may be utilized to determine engine state (e.g., operational speed, temperature, or the like). The sensor information may be analyzed and/or evaluated against a protection threshold to determine when the threshold is met or satisfied.

At 130, an action associated with the threshold may be initiated if the threshold value was satisfied at 125. In some embodiments, a proposed action may be presented within an interface for operator approval. For example, a unique message with an associated action may be presented when a threshold value is met. In some embodiments, when an engine speed matches an engine protection threshold value, an action may be presented to an operator allowing the operator to control engine speed. Alternatively, the action may be automatically performed without operator intervention.

At 135, an alarm message may be generated. For example, an alarm message may be generated in response to an engine protection occurrence (e.g., the satisfaction of an engine protection threshold). In some embodiments, an alarm message may be generated in response to an operator initiated action. At 140, the alarm message may be presented within the interface. For example, the alarm message can be presented within an operator message block of an interface. At 145, the alarm message may be recorded within an alarm log. For example, each engine protection setting (e.g., threshold value) may be associated with an individual alarm log. As another example, engine protection settings may be associated with a unified log that includes structure permitting selective aggregation and presentation of engine protection information. As one example, a unified log recording all alarm messages over a given time period may be employed. As another example, alarm messages may be organized in groups or sub-groups and recorded in corresponding logs.

At step 150, it is determined if one or more additional engine protection settings are available for evaluation. If so, the method may return to step 105 for evaluation and/or modification of an additional engine protection setting. Engine protection settings may be presented individually, each within a screen, grouped within one screen, or the like. For instance, a control panel of each engine protection setting can be presented within one screen allowing a top level view of all engine protection settings. At 155, the method may end.

Method 100 may be continuously performed during an operator interaction session. The method 100 may support multiple operators, interfaces, engines, safety systems, navigation systems, or the like. In one instance, the interface may be a graphical user interface associated with an EC2+™ system available from General Electric Company.

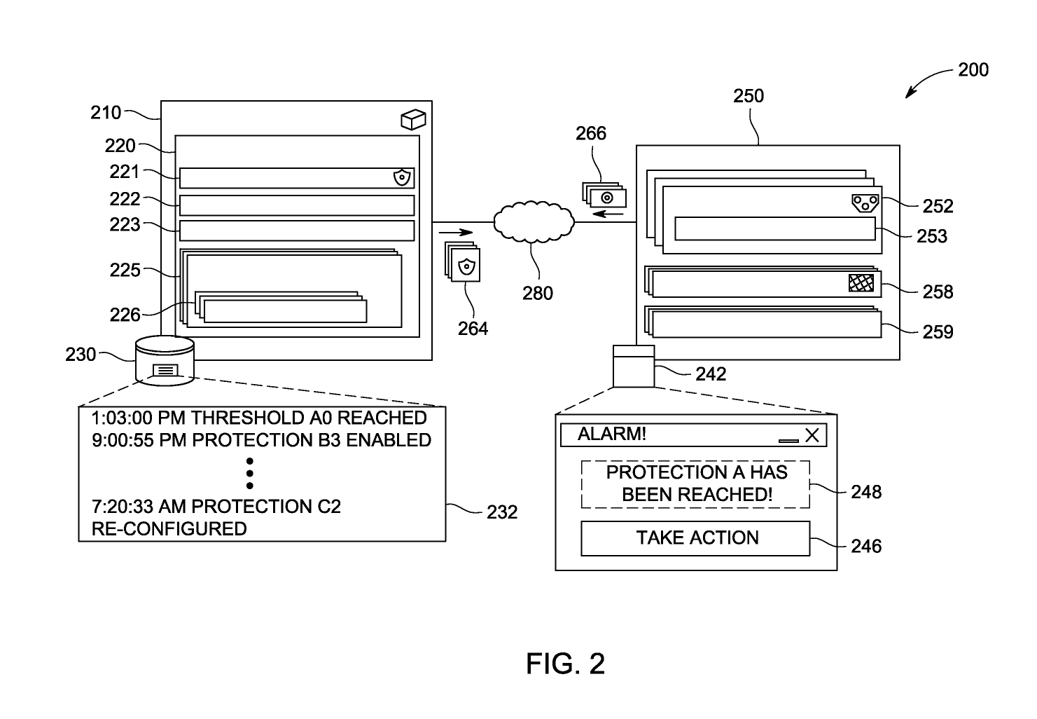

FIG. 2 is a schematic diagram illustrating a system 200 for unifying engine protection management within a vehicle or other engine-based device in accordance with an embodiment of the present inventive subject matter. The system 200 may be used with a marine vehicle in one embodiment, but not all embodiments of the system 200 are limited to being used with a marine vehicle. The system 200 may be utilized with all or a portion of the method 100 and/or the interface 300 described herein. Components of the system 200 components may be communicatively linked via a network 280. For example, an engine protection server 210 may be linked with a vehicle 250 via the network 280. The vehicle 250 may include an engine 252 having an engine control unit (ECU) 253, a sensor 258 configured to detect one or more operational parameters of the engine 252, and a control panel 259. The engine protection server 210 may include an engine protection module 220 associated with a data store 230.

The system 200 of the illustrated embodiment includes a protection server 210 configured to allow engine protection settings to be managed and/or configured relatively easily. One or more engine protection settings 226 may be conveyed to an interface 242 as protection data 264. The protection data 264 may include protection settings, protection history, or the like. The protection data 264 may be presented via an interface 242. The interface 242 may be associated with a control panel 259 configured to enable an operator to interact with an engine protection configuration module (e.g., engine protection module 220) including one or more engine protection settings 226. In some embodiments, the system 200 may be configured so that an external tool (such as a laptop and/or external software in addition to engine control software) may not be required to configure an engine protection configuration. Upon modification of one or more protection settings via the interface 242, the updated protection settings may be communicated to the server 210 as alteration information 266. In some embodiments, multiple disparate engine safety systems within a vehicle or other engine-based device/system may be administered within a manageable control point (e.g., control panel 259).

For example, an engine protection setting 226 may be created automatically based on the type of engine 252 (or, as another example, based on an operational mode of the engine 252). Engine operational parameters may be obtained from one or more sensors 258, ECU 253, external peripherals (not shown), or the like, which may be used to establish one or more relevant protection settings 226.

The vehicle 250 may be a vehicle such as a marine vehicle. As used herein, a marine vehicle may be a watercraft having at least one engine 252. The vehicle 250 may include, by way of example and not limitation, a boat, a vessel, a craft able to move through water, a stationary marine entity, or the like. The engine 252 may be a diesel engine able to power at least one system associated with the vehicle 250. For example, the engine 252 may be a component of a diesel generator configured to generate electricity. For example, the engine 252 in some embodiments may be a WARTSILA-SULZER or similar marine propulsion engine.

The ECU 253 may be an electronic control unit configured to manage operational parameters of the engine 252. The ECU 253 may include, for example, hardware, software, firmware, or the like. The ECU 253 may be configured, by way of example and not limitation, to manage fuel mixture control, ignition timing, idle speed control, variable valve timing, or the like. In some embodiments, the ECU 253 may receive a control action from the control panel 259 that results in modification of operational parameters of the engine 252.

In the illustrated embodiment, the sensor 258 may be an electronic component configured to detect or measure one or more operational parameters of the engine 252. The sensor 258 may include, but is not limited to, a temperature sensor, a strain sensor, a noise sensor, or the like. The sensor 258 may include sensors directly linked to engine 252, indirectly linked to engine 252, or the like. Further, the sensor 258 may include peripheral devices having metric recording functionality. It should be understood that, in some embodiments, the sensor 258 may be physically disparate from the engine 252.

The control panel 259 may be a hardware/software entity configured to present, among other things, information corresponding to the engine protection settings 226. The control panel 259 may include, but is not limited to, an interface 242, a human input device (e.g., keypad), a display, or the like. The control panel 259 in various embodiments may conform to traditional and/or proprietary configurations. In one embodiment, the control panel 259 may be a component of an instrument panel, control panel, navigation panel, and the like. For example, the control panel 259 may be a component of a dashboard within an engineering console. In one embodiment, the control panel 259 may be communicatively linked to a safety and input/output module.

The engine protection server 210 may be a hardware/software component for managing engine protection settings 226 linked to or associated with the engine 252 within the vehicle 250 or other vehicle or other engine-based device. The engine protection server 210 may include, but is not limited to, an engine protection module 220, a data store 230, or the like. The engine protection server 210 may be integrated within an on-board computing system of the vehicle 250 (or other vehicle or other engine-based device) in some embodiments. In some embodiments, the engine protection server 210 may be a component of an EC2+ diagnostics server. All or a portion of the structure and/or functionality of the engine protection server 210 may be incorporated within an existing computing system of the marine vehicle 250 (or other vehicle or other engine-based device). In some embodiments, the engine protection server may be a stand-alone entity.

The engine protection module 220 (which may in some embodiments be referred to as a protection engine) may be a hardware/software entity able to receive sensor information (e.g., from the sensor 258) and perform programmatic actions in response to the received sensor information. The engine protection module 220 may include, but is not limited to, a protection handler 221, a threshold manager 222, an action controller 223, a configuration settings module 225, or the like. In some embodiments, the engine protection module 220 may be a network element within a diagnostic system. In some embodiments, the engine protection module 220 may be a component of the control panel 259.

The protection handler 221 may be a hardware/software component configured to aid in managing and/or configuring engine protection settings 226. The protection handler 221 may be configured, by way of example and not limitation, for presentation of one or more engine protection settings, configuration (initial and/or updated) of one or more engine protection settings, or the like. The protection handler 221 may convey the protection data 264 upon request from the control panel 259, and enable real-time or near real-time presentation of engine protection settings 226. The protection handler 221 may also receive the alteration information 266 which may be utilized to update or modify the engine protection settings 226 in real-time or near real-time. In one embodiment, the protection handler 221 may be configured to display a sensor that is not communicatively linked to the engine 252. In some embodiments, the protection handler 221 may be utilized to present alarm messages, change history, or the like.

The threshold manager 222 may be a hardware/software entity configured to aid in managing, configuring, or utilizing threshold settings. The threshold manager 222 may be configured, for example, to evaluate one or more thresholds, verify one or more thresholds, present one or more thresholds, manage one or more thresholds, or the like. Management of a threshold may include, but is not limited to, adding a threshold, modifying a threshold, deleting a threshold, copying a threshold, and the like. For example, the threshold manager 222 may identify sensors which are associated with a threshold. In some embodiments, threshold selection may be performed via selection of a sensor. In some embodiments, the threshold manager 222 may permit identification of a sensor via a selected threshold. In various embodiments, the threshold manager 222 may present history threshold information, real-time threshold data, or the like.

The action controller 223 may be a hardware/software entity configured for the selection and/or execution of actions associated with an engine protection configuration, for example one or more engine protection settings 226. The action controller 223 may be configured to, among other things, log an alarm, present an alarm, or the like. For example, the action controller 223 may include simulation functionality enabling a protection configuration or setting to be tested prior to usage. A simulated protection activity may be executed within a simulator which can mimic engine parameters, performance, operation, or the like.

The configuration settings module 225 may be configured as a repository of engine protection configuration settings, and to provide flexibility to the engine protection server 210 and/or the system 200. The configuration settings module 225 may act as a repository, for example, for the engine protection settings 226, protection handler 221 settings, threshold manager 222 options, action controller 223 parameters, or the like. For example, the configuration settings module 225 may include or provide multiple options for the engine protection settings 226, which may be selected, for example, by an operator via the interface 242 and/or control panel 259. In some embodiments, one or more engine protection settings 226 may be set at default protection values pre-configured for marine vehicle (or other vehicle or other engine-based system) type, class, or operating mode. For example, based on a marine vehicle class, one or more default settings corresponding to the vehicle class may be established and selected for rapid configuration. In some embodiments, a configuration settings module 225 may present a plurality of pre-configured engine protection settings or configurations corresponding to respective operating modes. For example, a first configuration may include a plurality of settings corresponding to the engine 252 being operated in a marine mode, and a second configuration may include a plurality of settings corresponding to the engine 252 being operated in a genset (e.g., generator) mode. An operator may be presented with an option to select one of the modes via an interface. For example, if the operator chooses the “genset” operating mode, the configuration settings module 225 may then set the engine protection settings at the default values pre-configured for operation in the genset mode. The above is meant by way of example, as additional modes or types of modes of operation may be employed in various embodiments. For example, in various embodiments, the configuration settings module 225 may include pre-configured engine protection setting information corresponding to modes such as ferry operation, dredging operation, barge operation, or the like. Further, pre-configured settings may be made available for modes corresponding to particular customers and/or particular applications.

The data store 230 may include, among other things, an alarm log 232. The alarm log 232 may include one or more data sets associated with an incident event (or events) within the system 200. The alarm log 232 may include, without limitation, timestamp information, threshold values, alarm messages, engine state information, engine parameters, control actions, or the like. In one embodiment, the alarm log 232 may be generated for each engine within the vehicle 250 (or other engine-based device). In another embodiment, the alarm log 232 may be configured as an aggregate alarm log 232 generated for all engines, or a group or sub-group of engines, of the vehicle 250 (or other engine-based device). For example, engines may be uniquely identified permitting auditing policies to be achieved. The alarm log 232 may conform to traditional and/or proprietary formats including, but not limited to, text, Extensible Markup Language (XML), Hypertext Markup Language (HTML), or the like. The alarm log 232 thus may be easily parsed and/or manipulated during processing (e.g., analysis, auditing).

The interface 242, in some embodiments, may be a user interactive component configured to allow interaction with, for example, an alarm message 248 and/or the control panel 259. The interface 242 may be a graphical user interface (GUI), voice user interface (VUI), mixed-mode interface, touch sensitive interface, or the like. The interface 242 may include, but is not limited to, a desktop interface, a Web-based interface, a mobile interface, or the like. The interface 242 may present the alarm message 248, which, in some embodiments, may describe or include relevant operator actions (e.g., element 246) which may be performed. For instance, when an engine protection threshold is reached, the alarm message 248 may be presented within the interface 242. In some embodiments, the interface 242 can be utilized to authorize an engine control action (e.g., action 246). In some embodiments, the interface 242 may be associated with an interface of a safety and input/output module.

The data store 230 may be a hardware/software component able to store, among other things, the alarm log 232. The data store 230 may be a Storage Area Network (SAN), Network Attached Storage (NAS), or the like. The data store 230 may conform to a relational database management system (RDBMS), object oriented database management system (OODBMS), or the like. The data store 230 may be communicatively linked to the engine protection server 210 via one or more traditional and/or proprietary mechanisms.

The network 280 may be an electrical and/or computer network connecting one or more components of the system 200 (e.g., the engine protection server 210 and one or more aspects of the vehicle 250). The network 280 may include, without limitation, twisted pair cabling, optical fiber, coaxial cable, or the like. The network 280 may include any combination of wired and/or wireless components. Topologies of the network 280 may include, without limitation, bus, star, mesh, or the like. Types of the network 280 types may include, without limitation, Local Area Network (LAN), Wide Area Network (WAN), Virtual Private Network (VPN) or the like.

It should be appreciated that various components or elements discussed herein (e.g. elements 220-225 and 242-259) may include or be embodied in connection with traditional and/or proprietary hardware/software components including, but not limited to, microprocessors, read-only memory (ROM), random access memory (RAM), electrically erasable programmable read-only memory (EEPROM), or the like. It should be understood that the system 200 may be configured to permit configuration of engine protection settings or configurations in real-time or near real-time, enabling, for example, rapid reaction to specific emergency scenarios.

It should be noted that various embodiments of the disclosure may include a “drop-in” solution for traditional engine protection approaches. For example, the system 200 may be integrated within an existing engine protection/safety framework without requiring extensive changes to the existing framework. The system 200 may be a component of a distributed network environment, distributed computing system, or the like. It should be appreciated that the system 200 in various embodiments may support multiple protection configurations or settings for each operator, engine type, engine, or the like. It should be understood that the functionality of the system 200 may be encapsulated within an application programming interface, associated with a Web-enabled service, and the like.

FIG. 3 is a schematic diagram illustrating an interface 300 that may be used to unify engine protection management within a vehicle (e.g., a marine vehicle) or other engine-based device (e.g., generator) in accordance with an embodiment of the present inventive subject matter. The interface 300 may be utilized, for example, in the context of the method 100 and/or the system 200. It should be appreciated that elements (e.g., elements 322-328) within the interface 300 may be interactive elements (e.g., may be displayed, entered, and/or modified by an operator using an interactive interface). For example, the interface 300 may be a common functional display of an EC2+ diagnostic system. In some embodiments, an EC2+ diagnostic system may be configured so that an external tool (such as a laptop and/or external software in addition to engine control software) may not be required to configure an engine protection configuration. In some embodiments, the interface 300 or values or settings depicted thereon may be customizable based on vehicle (or other engine-based device) capabilities or mode of operation, engine functionality, available sensor data, operator preferences, or the like. For example, the interface 300 may conform to a traditional gauge panel layout. The interface 300 may be a graphical user interface configured to visually present configuration settings for one or more engine protections (e.g., via a screen or touchscreen).

As discussed below in connection with FIG. 3, an engine protection configuration may be understood as an overall scheme, grouping, or organization of various aspects arranged to provide protection to an engine. Engine protection settings may be understood as particular values assigned to aspects of a configuration for a given desired level, arrangement, or type of engine protection. For example, an engine protection configuration may include a plurality of settings arranged as suites. A suite may include, for example, a threshold value along with a corresponding message and action. The message may be displayed when the corresponding threshold value is satisfied. Similarly, in some embodiments, the corresponding action may be performed when the respect threshold value is satisfied. In other embodiments, the action may be displayed to an operator as a proposed action when the corresponding threshold value is satisfied, and the operator may approve the proposed action to be performed, or select for the action not to be performed.

The interface 300 may include a display section 320, by which various engine performance characteristics can be presented in real-time. In various embodiments, the section 320 may conform to traditional and/or proprietary display formats including, textual data, graphical data, and the like. In some embodiments, the section 320 may present multiple engine protection configurations simultaneously. In some embodiments, the section 320 may present engine data for each engine independently. That is, a screen for each engine can be presented upon request. For example, each engine protection may be visually separated into pages.

In the illustrated embodiment, the interface element 322 is configured to allow engine protection threshold selection within section 320. It should be understood that element 322 can support an arbitrary quantity of threshold settings. For example, element 322 can present three threshold settings for an engine protection (e.g., Threshold A0, Threshold B3, Threshold C2). In one embodiment, the elements 322-326 may be linked as one or more protection suites allowing selection of a threshold within element 322 to present relevant message 324 and action 326 configuration settings. For example, selection of Threshold A0 can present Message A0 and Action A0.

The interface element 324 may be a unique alarm message associated with a threshold of an engine protection. For example, element 324 can be an editable text box permitting the modification of an operator specified message. In some embodiments, the alarm message can be configured to be presented when a threshold value of an engine protection setting is reached. For example, a Message A0 can be configured to present a custom warning message to an operator within an interface when Threshold A0 is met.

The interface element 326 may be configured to present an action (or a plurality of actions) associated with a threshold of an engine protection. For example, the element 326 may allow action selection based on a pre-determined list of actions. In some embodiments, the element 326 may present a disable action, a warning action, a slowdown request action, and/or a shutdown action. In some embodiments, the interface 300 can support macros that may allow multiple actions to be aggregated into one customized action. For example, Action A0 can be a series of actions utilized in performing an emergency stop procedure.

As discussed above, the threshold A0, Message A0, and Action A0 may thus be considered an engine protection suite. A given protection configuration (e.g., “Protection A” of FIG. 3) may include a plurality of such suites to provide various actions and/or alarms at various different threshold values (e.g. suit A0 corresponds to one threshold value, B3 to a second, and C2 to a third).

For instance, the threshold A0 may correspond to an engine temperature (or other measured parameter) at which a warning may be appropriate, but action may not necessarily be required, the threshold B3 may correspond to a higher engine temperature at which a slowdown may generally be appropriate, and the threshold C2 may correspond to a still higher engine temperature at which shutdown may generally be appropriate. In an example scenario, as an engine in use begins to heat, information from a temperature sensor is provided to an engine protection module (e.g., engine protection module 220). As the temperature reaches and satisfies the threshold A0, the message A0 may be displayed via an interface. The message A0 may include text and/or symbols indicating a rising temperature to an operator. Similarly, the action A0 may be presented as an option to the operator. For example, the action A0 may include a slowdown option that will slow the engine down if selected or otherwise authorized by the operator. As the temperature continues to rise, the threshold B3 may be satisfied, at which point the message B3 may be displayed to an operator, indicating that the threshold B3 has been satisfied. The action B3 may be presented to the operator as well. The action B3, for example, may be a slowdown action which may be selected or authorized by the operator. As the temperature continues to rise, the threshold C2 may be satisfied, an alarm message C2 (e.g., an alarm message indicating that a temperature has been reached at which shut down may be appropriate), and an action C2 (e.g., a shutdown action) may be presented as an option to the operator. In some embodiments, the operator may choose the presented action, may be provided with a plurality of potential actions, or may have the opportunity to implement an action other than a displayed action. In some embodiments, the proposed action may be performed as a default action if the operator does not over-ride the proposed action or otherwise actively choose for the proposed action to be avoided.

Further, various configurations may be displayed and/or modified using interface 300. For example, “Protection A” may correspond to a genset setting and “Protection B” to a marine setting. An operator thus may input the mode of operation, (e.g., “genset” or “marine”), and a pre-configured or predetermined configuration of protection settings corresponding to the input mode of operation may be implemented. For example, “Protection A” may be implemented when a “genset” mode of operation is selected. Further, in some embodiments, an operator may selectively customize individual settings as desired. In other embodiments, various configurations may be selected based on class of engine or vehicle, customer, application, conditions, or the like.

In the illustrated embodiment, the element 328 is configured to present one or more logs associated with engine protection. In some embodiments, the element 328 may be configured to present an alarm log for a given engine protection configuration (e.g., “Protection A). For example, a pop-up dialog box can present relevant incident details for “Protection A”. For example, information (including timing, any action taken, or the like) may be provided for each instance of satisfaction of the thresholds A0, B3, or C2. In some embodiments, customization options may allow dynamic views of incident details. Customization options may include, without limitation, filters, prioritization, searchable criteria, or the like.

The interface 300 may be associated with a local computing device, remote computing device, or the like. It should be appreciated that, in some embodiments, one or more portions of the interface 300 may be presented within an engine diagnostic peripheral. The interface 300 may be associated with a computing device (such as the engine protection module 220), the engine protection server 210, or the like. It should be noted that the interface 300 may be configured for, without limitation, incident log auditing, testing, diagnostic functions, or the like. The interface elements 322-328 may include, without limitation, a selection box, a radio dialog, text box, or the like. It should be understood that functionality within the interface 300 may be presented within a file menu, a context menu, and the like.

Thus, embodiments of the present inventive subject matter provide systems and methods for protecting engines using, for example, engine protection configurations. An operator may use various screens to configure parameters or settings associated with various engine protection configurations. In some embodiments, a protection configuration has multiple thresholds with unique alarm messages displayed for each particular threshold. The thresholds (along with alarm messages and/or associated actions) may configured by an operator, and may be run-time configurable. Each protection configuration may have multiple actions and/or restrictions associated with the multiple thresholds. In some embodiments, if a particular sensor is not connected for a given application, and/or if a sensor is logging nuisance alarms, some or all of the protection configurations may be disabled. Further, in some embodiments, each instances of a threshold being satisfied may be logged or recorded for future analysis. If a protection setting is re-configured or updated, an existing alarm may be reset automatically and new alarm based on the new settings may be logged. Further, the persistence time (e.g., the time a system waits for logging an alarm) may be configurable is some embodiments. Updates or changes to configuration may be saved into a system so that the updated values may be used when one or more control panels are powered up at a future time. All of the various configuration options may be consolidated into a single software unit provided to a customer and may not require any external tools.

Embodiments of the present invention thus may provide for improved flexibility for the configuration and/or modification of engine protection settings, including thresholds. For example, protection settings may be conveniently modified or re-configured to account for different sensor types; different customer requirements, procedures or preferences; different classes or types of engines or other components; and different conditions or applications associated with an engine. For example, one group of engine protection settings may be configured for a marine operation and a different group of engine protection settings may be configured for a genset operation. An operator may conveniently select between such configurations or groups of settings using an interface as described herein. As additional example, engine setting configurations may be selectable and/or customizable for modes of operation such as ferry operation, dredging operation, barge operation, or the like.

The flowchart and block diagrams of FIGS. 1-3 illustrate examples of the architecture, functionality, and operation of possible implementations of systems, methods and computer program products according to various embodiments of the present inventive subject matter. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one embodiment, a method (e.g., a method for engine protection configuration) is provided including providing a run-time configurable engine protection configuration. The engine protection configuration is stored in an engine protection module that is linked to a sensor associated with an engine. The method also includes identifying an engine protection setting corresponding to the engine protection configuration. The engine protection setting includes at least three of a threshold value, a unique message, an action or an alarm. The method further includes presenting the engine protection setting to an operator via an interface. The interface includes at least one of a control panel or a computing device. Also, the method includes receiving, via the interface, an instruction corresponding to a revised engine protection setting. Further the method includes updating, during run-time, the engine protection configuration pursuant to the instruction to reflect the revised engine protection setting, responsive to the receiving of the instruction corresponding to the revised engine protection setting.

In another aspect, the threshold value may be at least one of a temperature, vibration, speed, torque, or fuel consumption. In another aspect, the unique message may be at least one of a user customizable message or an automatically created message. In still another aspect, the action may be at least one of a disable, warning, slowdown request, or shutdown. In yet another aspect, the alarm may be at least of a visible or audible alarm. In an embodiment, the disable action may include disabling one or more aspects of an engine. In an embodiment, the disable action may include the disabling of one or more engine protections (e.g., due to an improperly operating sensor resulting in nuisance alarms). In an embodiment, the warning may include a notification to an operator configured to alert the operator of a condition of the engine or of the operation of the engine beyond a desired threshold. In an embodiment, the slowdown request may include a notification (e.g., via a screen or other display) requesting the operator to reduce an effort made by the engine. In an embodiment, the shutdown may include shutting down the engine based on the engine exceeding a threshold.

In another aspect, a control panel associated with the engine protection configuration is not power cycled responsive to receiving the instruction corresponding to the revised engine protection setting. Further, the control panel may be an instrument panel associated with at least one of a marine engine system, a marine engine safety system, or a navigation system.

In another aspect, the engine protection setting includes a corresponding first threshold value, first message and first action. The revised engine protection setting includes a corresponding second threshold value, second message, and second action that differ from the first threshold value, first message, and first action.

In another aspect, the engine protection setting and the revised engine protection setting each include plural engine protection suites. Each engine protection suite includes a corresponding threshold value, message, and action.

In another aspect, the engine protection setting may be associated with and configured for a first mode of operation, and the revised engine protection setting may be associated with and configured for a second mode of operation. For example, the first mode of operation may be one of ferry operation, dredging operation, barge operation, genset operation, or the like. The second mode of operation may be a different one of ferry operation, dredging operation, barge operation, genset operation, or the like

In another embodiment, a system (e.g., a system for engine protection) is provided including an engine protection module and a data store. The engine protection module is configured for run-time updating of an engine protection configuration associated with an engine. The protection configuration includes a protection setting including at least three of a threshold value, a unique message, an action or an alarm. The data store is configured to store at least one of the engine protection configuration or an alarm log. The alarm log includes at least one of a timestamp, an engine state, a threshold, or an alarm message.

In another aspect, the system may include a protection handler, a threshold manager, and an action controller. The protection handler is configured to identify an engine protection configuration associated with a sensor. The sensor is configured to measure an engine parameter of the engine during run-time. The threshold manager is configured to determine when the engine parameter measured by the sensor satisfies the threshold value of the engine protection configuration. The action controller is configured to select at least one permissible engine operation based on the engine parameter using the engine protection configuration. Further, the engine operation may be at least one of a disable, warning, slowdown request, or shutdown.

In another aspect, the system may include plural configurable engine protection configurations, with each engine protection associated with a unique alarm log. In another aspect, the system may include an interface configured to allow an operator to at least one of select or modify the engine protection configuration.

In another aspect, the engine protection setting includes a corresponding first threshold value, first message and first action. The revised engine protection setting includes a corresponding second threshold value, second message, and second action that differ from the first threshold value, first message, and first action.

In another aspect, the engine protection setting and the revised engine protection setting each include plural engine protection suites. Each engine protection suite includes a corresponding threshold value, message, and action.

In another embodiment, a tangible and non-transitory computer readable medium includes one or more computer software modules. The computer software modules are configured to direct a processor to provide a run-time configurable engine protection configuration; identify an engine protection setting corresponding to the engine protection configuration; present the engine protection setting to an operator via an interface; receive, via the interface an instruction corresponding to a revised engine protection setting; and update, during run-time, the engine protection configuration. The engine protection configuration is stored in an engine protection module that is linked to a sensor associated with an engine. The engine protection setting includes at least three of a threshold value, a unique message, an action, or an alarm. The interface includes at least one of a control panel or a computing device. The engine protection configuration is updated pursuant to the instruction to reflect the revised engine protection setting, responsive to receiving the instruction corresponding to the revised engine protection setting.

In another aspect, the engine protection setting includes a corresponding first threshold value, first message and first action. The revised engine protection setting includes a corresponding second threshold value, second message, and second action that differ from the first threshold value, first message, and first action.

In another aspect, the engine protection setting and the revised engine protection setting each include plural engine protection suites. Each engine protection suite includes a corresponding threshold value, message, and action.

In another aspect, the engine protection setting is associated with and configured for a first mode of operation, and the revised engine protection setting is associated with and configured for a second mode of operation.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, controllers or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the presently described inventive subject matter are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

1. A method for engine protection configuration comprising:
providing a run-time configurable engine protection configuration, wherein the engine protection configuration is stored in an engine protection module that is linked to a sensor associated with an engine;
identifying an engine protection setting corresponding to the engine protection configuration, wherein the engine protection setting includes at least three of the following: a threshold value, a unique message, an action, or an alarm;
presenting the engine protection setting to an operator via an interface, wherein the interface comprises at least one of a control panel or a computing device;
receiving, via the interface, an instruction corresponding to a revised engine protection setting; and,
updating, during run-time, the engine protection configuration, pursuant to the instruction, to reflect the revised engine protection setting, responsive to the receiving of the instruction corresponding to the revised engine protection setting.

2. The method of claim 1, wherein the threshold value is at least one of a temperature, vibration, speed, torque, or fuel consumption.

3. The method of claim 1, wherein the unique message is at least one of a user customizable message or an automatically created message.

4. The method of claim 1, wherein the action is at least one of a disable, warning, slowdown request, or shutdown.

5. The method of claim 1, wherein the alarm is at least one of a visible or audible alarm.

6. The method of claim 1, wherein the control panel is not power cycled responsive to receiving the instruction corresponding to the revised engine protection setting.

7. The method of claim 6, wherein the control panel is an instrument panel associated with at least one of a marine engine system, a marine engine safety system, or a navigation system.

8. The method of claim 1, wherein the engine protection setting comprises a corresponding first threshold value, first unique message, and first action, and wherein the revised engine protection setting comprises a corresponding second threshold value, second unique message, and second action that differ from the first threshold value, first unique message, and first action.

9. The method of claim 1, wherein the engine protection setting and the revised engine protection setting each comprise plural engine protection suites, each engine protection suite comprising a corresponding threshold value, message, and action.

10. The method of claim 9, wherein the engine protection setting is associated with and configured for a first mode of operation, and wherein the revised engine protection setting is associated with and configured for a second mode of operation.

11. A system for engine protection comprising:
an engine protection module configured for run-time updating of an engine protection configuration associated with an engine, wherein the engine protection configuration comprises an engine protection setting comprising at least three of the following, a threshold value, a unique message, an action, or an alarm; and
a data store configured to store at least one of the engine protection configuration or an alarm log, wherein the alarm log comprises of at least one of a timestamp, an engine state, a threshold indicator, or an alarm message.

12. The system of claim 11, further comprising:
a protection handler configured to associate the engine protection configuration with a sensor, wherein the sensor is configured to measure an engine parameter of the engine during runtime;
a threshold manager configured to determine when the engine parameter measured by the sensor satisfies the threshold value of the engine protection configuration; and
an action controller configured to select at least one permissible engine operation based on the engine parameter using the engine protection configuration.

13. The system of claim 12, wherein the engine operation is at least one of a disable, warning, slowdown request, or shutdown.

14. The system of claim 11, further comprising plural configurable engine protection configurations, wherein each engine protection configuration is associated with a unique alarm log.

15. The system of claim 11, further comprising an interface configured to allow an operator to at least one of select or modify the engine protection configuration.

16. The system of claim 11, wherein the engine protection setting comprises a corresponding first threshold value, first message, and first action, and wherein a revised engine protection configuration comprises a corresponding second threshold value, second message, and second action that differ from the first threshold value, first message, and first action.

17. The system of claim 16, wherein the engine protection setting and the revised engine protection setting each comprise plural engine protection suites, each engine protection suit comprising a corresponding threshold value, message, and action.

18. A tangible and non-transitory computer readable medium comprising one or more computer software modules configured to direct a processor to:
provide a run-time configurable engine protection configuration, wherein the engine protection configuration is stored in an engine protection module that is linked to a sensor associated with an engine;
identify an engine protection setting corresponding to the engine protection configuration, wherein the engine protection setting includes at least three of the following: a threshold value, a unique message, an action, or an alarm;
present the engine protection setting to an operator via an interface, wherein the interface comprises at least one of a control panel or a computing device;
receive, via the interface, an instruction corresponding to a revised engine protection setting; and,
update, during run-time, the engine protection configuration pursuant to the instruction to reflect the revised engine protection setting, responsive to receiving of the instruction corresponding to the revised engine protection setting.

19. The computer readable medium of claim 18, wherein the engine protection setting comprises a corresponding first threshold value, first message, and first action, and wherein the revised engine protection setting comprises a corresponding second threshold value, second message, and second action that differ from the first threshold value, first message, and first action.

20. The computer readable medium of claim 18, wherein the engine protection setting and the revised engine protection setting each comprise plural engine protection suites, each engine protection suite comprising a corresponding threshold value, message, and action.

21. The computer readable medium of claim 18, wherein the engine protection setting is associated with and configured for a first mode of operation, and wherein the revised engine protection setting is associated with and configured for a second mode of operation.
